(19) United States
(12) Patent Application Publication
(10) Pub. No.: US 2011/0126179 A1
(43) Pub. Date: May 26, 2011

(54) Method and System for Dynamic Patching Software Using Source Code

(76) Inventors: Thomas HARTMAN, Bayern (DE); Ka Kay ACHACOSO, Union City, CA (US); Bulent KASMAN, Antioch, CA (US); Sebastian KRAWCZUK, Alameda, CA (US)

(21) Appl. No.: 12/624,535

(22) Filed: Nov. 24, 2009

(51) Int. Cl. G06F 9/45

(52) U.S. Cl. 717/140; 717/136

(57) ABSTRACT

Systems and methods for extracting an original source code for an application, the original source code including source code for a function, receiving source code for a new function, the source code being a same type as the original source code, the new function to replace the function in the application, determining information from one of the original source code and an execution of the application and transforming the source code for the new function into transformed source code based on the information determined from the original source code.

### BACKGROUND

Software developers often need to change or rewrite code for functions or procedures in a software project. Often times the project is already compiled and running. When this is the case the developer needs to go through a series of time consuming steps to substitute in the new function into the project. In addition to the actual writing of the new or substitute code, these steps include taking the project offline, substituting the new source code into the project, recompiling the source code into object code and then machine code, linking the code, debugging the code and possibly optimizing the code in some manner. In a large software project, new code may be substituted hundreds of times. Thus, software developers working on such a project may have to perform these above steps each time new code needs to be substituted into the operating code. Thus, many man hours are added to a project because of these time consuming steps.

### SUMMARY OF THE INVENTION

A system including a memory storing a set of instructions executable by a processor, the set of instructions being operable to extract an original source code for an application, the original source code including source code for a function, receive source code for a new function, the source code being a same type as the original source code, the new function to replace the function in the application, determine information from one of the original source code and an execution of the application and transform the source code for the new function into transformed source code based on the information determined from the original source code.

A system having a target device executing an application and a host device generating a new function to replace an existing function in the executing application of the target device, wherein the generating includes extracting an original source code for the application, the original source code including source code for the exiting function, receiving source code for the new function, the source code being a same type as the original source code, determining information from one of the original source code and the execution of the application on the target device and transforming the source code for the new function into transformed source code based on the information determined from the original source code.

A system having means for extracting an original source code for an application, the original source code including source code for a function, means for receiving source code for a new function, the source code being a same type as the original source code, the new function to replace the function in the application, means for determining information from one of the original source code and an execution of the application and means for transforming the source code for the new function into transformed source code based on the information determined from the original source code.

### BRIEF DESCRIPTION OF THE DRAWINGS

FIG. 1 shows an exemplary system for generating, transforming, compiling and executing a new function within a running application according to an exemplary embodiment.

FIG. 2 shows an exemplary embodiment of a method for generating, transforming, compiling and executing a new function within a running application according to an exemplary embodiment.

FIG. 3 shows an exemplary block diagram of a running application and a new function to be inserted into the running application according to an exemplary embodiment.

### DETAILED DESCRIPTION

The exemplary embodiments may be further understood with reference to the following description and the related appended drawings, wherein like elements are provided with the same reference numerals. The exemplary embodiments are related to systems and methods used to dynamically replace a function in a running application by generating the replacement function from source code. The dynamic replacement of the function will be called “dynamic patching” throughout this description. It should also be noted that the exemplary embodiments will be described with reference to replacing a “function” in a running “application.” The term “function” should be understood to mean any subset of code within the larger application and is not limited to only those sections of code that are labeled as functions. Similarly, the term “application” should be understood to mean any complete set of code that can be executed to perform a specific task such as an application, an operating system, a kernel, a driver, etc. Dynamic patching may allow software developers and engineers to insert new or replacement functions within an application on a device in a field environment without shutting down or rebooting the device or the application. This process may be extremely useful when shutting down or rebooting the device is undesirable or even impossible. In addition, it saves the time of recompiling the entire application each time a new or revised function needs to be inserted into the application.

Software applications are often created on a host computing device and ported to a target device. This type of development is typical for embedded devices. An embedded device is any device that includes a processor or microcontroller that executes software to carry out desired functions. Normally, an embedded device has fewer resources than a general purpose computer, such as having a slower processor, less memory (cache, RAM, Flash, etc.), etc. Examples of embedded devices include mobile phones, personal digital assistants, smart phones, smart process monitoring devices (e.g., thermostats, pressure sensors, flow sensors, etc.), etc. The exemplary embodiments of the present invention will be described with reference to an editing tool for such embedded devices. However, those skilled in the art will understand that the present invention may be implemented in, for example, an editing tool for software executing on any type of device.

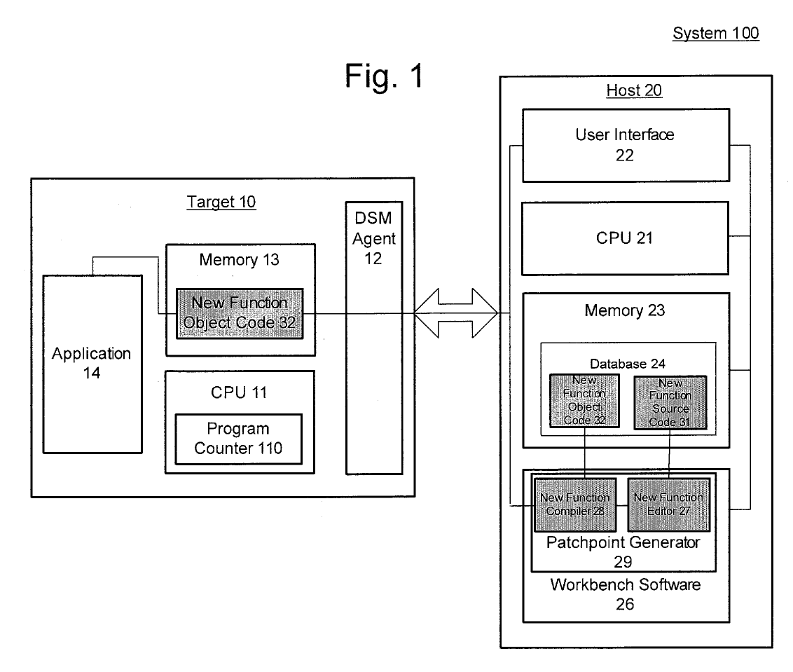

FIG. 1 shows an exemplary system 100 for integrating the editing, compiling and installing of program code within an application according to exemplary embodiments of the present invention. The system 100 includes a target device 10 and a host device 20. In one embodiment, both the target 10 and the host 20 may be located in a lab environment, while in another embodiment, the target 10 and/or the host 20 may be in a field environment. For example, the target 10 may be deployed in a warehouse, office, etc., while the host resides in a laboratory or central server location. The host 20 may include conventional computing components such as a central processing unit (“CPU”) 21 (e.g., a microprocessor, an embedded controller, etc.) and a memory 23 (e.g., Random Access Memory, Read-only Memory, a hard disk, etc.). Likewise, the target 10 may also include a CPU 11 and a memory 13. Communication between the target 10 and the host 20 occurs over a communication link, which may be a wired (e.g., Ethernet, serial port, Universal Serial Bus, etc.) or wireless (e.g., Bluetooth, IEEE 802.1x, etc.) connection.

The host 20 may further include a user interface 22, a database 24, and workbench software 26. The user interface 22 enables a developer (e.g., a user) to interact with the host 20 by receiving instructions and data requests. Throughout the description, the term developer will be used to refer to a user of the system and method disclosed herein, wherein a user may be a software engineer, a test engineer, a quality assurance engineer, support personnel, etc.

The user interface 22 may comprise any number of standard input and/or output devices, such as a keyboard, a mouse, a display, etc. Through the user interface 22, the developer may instruct the host 20 to transmit data to and/or from the target 10. The data may include the new functions to be inserted into the application running on the target 10.

The workbench software 26 is a software development tool used by the developer to create, modify, and debug software programs. The workbench software 26 may comprise a software suite that includes any number of individual software development programs, such as a compiler, a debugger, a source code analyzer, a text editor, etc. These individual programs may either be run independently of a running application or within a main development program. In the example of FIG. 1, the workbench software includes a software module termed the patchpoint generator 29 that is the module for generating and compiling the new function. Similar to the workbench software 26, the patchpoint generator 29 may also include additional modules and/or functionality from that described herein. In this example, the patchpoint generator 29 is shown as including the editor 27 and the compiler 28. Using the editor 27 and the compiler 28 of the patchpoint generator 29, the developer can write and edit code for the new function, compile the new function and save the new function to the database 24 or as a local file system. This functionality will be described in greater detail below. Once the new function is saved, it may be compiled and selected for transmission to the target 10.

The database 24, or the local file system, may store the new function and other types of data specified by the developer. As illustrated in FIG. 1, the database 24 is shown as storing the source code 31 and the object code 32 for the new function. The database 24 may also include user information, customer information, information regarding the target 10 (e.g., device type), parameter information regarding a business process, etc. The database 24 may be organized in any number of ways, including separate data structures for holding information corresponding to a specific target, a specific data type (e.g., functions), etc. The database 24 is located on writable memory 23, and may be accessed via the user interface 22.

The target 10 may include a Device Software Management (DSM) agent 12 that communicates with the host 20 via the communication link. The DSM agent 12 coordinates the sending and receiving of data. Instructions and data requests are received by the DSM agent 12 and processed accordingly. When data is transmitted or received, the DSM agent 12 may first place the data into a buffer. For example, received functions may be temporarily stored in a buffer before writing to the memory 13 of the target 10. Likewise, data transmitted to the host 20 may first be placed in a buffer and sent when the data is ready for transmission and/or the host 20 is ready to receive the data. The DSM agent 12 may be implemented in hardware, software, or a combination thereof.

The target 10 executes an application 14, which comprises user code running in an operating system or a stand-alone program. The application 14 may be written in any programming language (e.g., C/C++, Java, Assembly language, etc.). The application 14 may be any program that the developer wishes to run on the target 10. For example, the application 14 may be a main program or subroutine being developed for implementation on the target 10. As will be described in greater detail below, the application 14 that is executed on the target 10 is a compiled program may include source, header, library, object, and other data files.

The target 10 may also include new function object code 32. As illustrated in FIG. 1, the new function object code 32 is stored on both the host 20 and the target 10. As will be described in greater detail below, the new function object code 32 is compiled on the host 20 and then ported to the target 10 for execution. Similar to the application 14, the new function object code 32 may include source, header, library and object files. According to the exemplary embodiments of the present invention described herein, a new function is defined as a piece of code that is compiled independently of a running application (e.g., the compiled application 14). The new function object code 32 may be executed by the running application via branch instructions inserted into the running application (e.g., the executable binary).

The target 10 may also include a program counter 110. The program counter 110 may be defined as a component of the CPU 11 that indicates which instruction in an instruction sequence is currently being executed and may contain the address of the next instruction that is to be executed. In other words, the program counter 110 may indicate a location, or address, in the memory 13 for currently executing instructions and the next instructions to be executed. The program counter 110 may be automatically incremented for each cycle of the instruction sequence so that instructions are retrieved in proper sequential order from the memory 13. However there may be certain instructions, such as a branch (or jump) instruction, that interrupt the sequence by placing a new value in the program counter 110. The program counter 110 may be a component that indicates which instruction in an instruction sequence is currently being executed on the target 10 and may contain the memory address of the next instruction that is to be executed. Certain instructions, such as a branch instruction may interrupt the instruction sequence by placing a new value in the program counter 110. The branch instruction may be described as a break in the instruction sequence of computer processing, wherein the address of the branch instruction is not in the next sequential storage location in memory 13. Thus, one manner of dynamically patching the new function into the running application may be through the use of such branching instructions. That is, as the application 14 executing on the target 10 a branch instruction is encountered sending instructions to the CPU 11 to begin executing the new function 32. When the new function 32 is finished executing, the branch instruction sends the CPU 11 back to the program 14 to continue execution. Those skilled in the art will understand that there may be other manners of inserting the new application into the running program and the use of branch instructions is only exemplary.

Those skilled in the art will understand that the system 100 and the various components described for the host 20 and the target 10 are only exemplary and are being used to illustrate an exemplary embodiment for dynamically patching a new function into an application on the target 10. However, dynamic patching of the exemplary embodiments may be implemented on systems that do not include the components described herein.

The above generally described an exemplary system and method for dynamically patching a new function into a running application. However, the exemplary embodiments are also concerned with the writing and compiling of the new function. That is, as described above, the host 20 includes components that are used to write and compile the new function. Moreover, as also described above, the exemplary embodiments allow for the developer to write the new function in the native source code of the application 14. This process will be described in greater detail below.

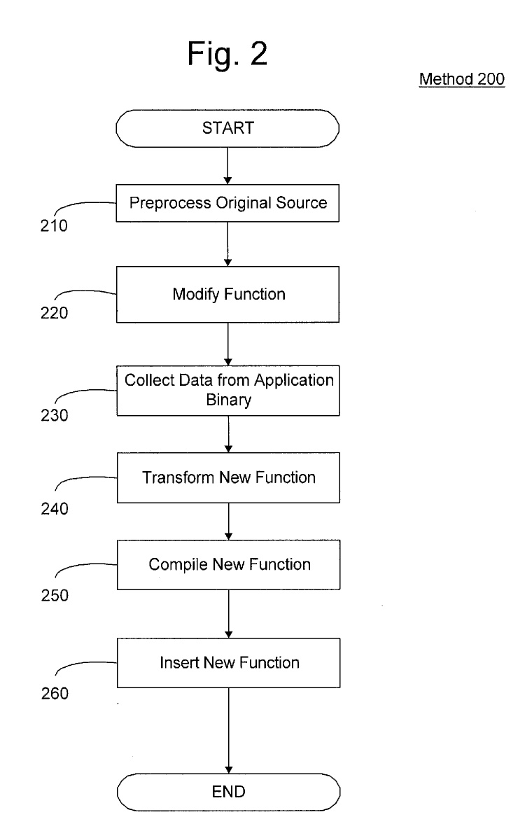

FIG. 2 shows an exemplary method 200 for dynamic patching a new function into a running application according to the exemplary embodiments that will be discussed with reference to the system 100. Beginning with step 210, the original source code for the application 14 is preprocessed so that the new function may be inserted into the running application. This preprocessing includes extracting, by the editor 27 of the workbench 26, the original source code of the application 14. The original source code may be stored on the host 20 or the target 10, but typically will be stored in the memory 23 of the host 20. If the original source code is stored on the target 10, the workbench 26 may communicate with the DSM agent 12 of the target 10 to request that a copy of the original source code be sent to the host 20.

The preprocessing of the original source code in step 210 may also include additional actions to be performed on the original source code. Those skilled in the art will understand that these additional actions may be different actions based on different types of compilers for different types of source code. However, in general, the preprocessing step performs actions which prepares the source code to be compiled such as converting the source into a character set, performing textual transformations, tokenization, resolving header invocations, resolving macros, etc. With respect to the remainder of this description, the exemplary embodiments will be described with reference to the header files, however, it should be understood by those skilled in the art that corresponding or similar actions may be taken on other types of files and/or programming constructs to allow for the new function to be compiled outside its natural environment.

A header file is typically a file containing declarations and macro definitions to be shared between several source files. A header file is used in a function by including it, for example, with the programming ‘#include’. Header files generally serve two purposes. First, system header files declare the interfaces to parts of the operating system. System header files are included to supply the definitions and declarations needed to invoke system calls and libraries. User header files contain declarations for interfaces between the source files of the application. Including a header file produces the same results as copying the header file into each source file that needs it. Such copying would be time-consuming and error-prone. With a header file, the related declarations appear in only one place. If they need to be changed, they can be changed in one place, and programs that include the header file will automatically use the new version when next recompiled. The header file eliminates the labor of finding and changing all the copies as well as the risk that a failure to find one copy will result in inconsistencies within a program. Those skilled in the art will understand that the above description of header files is only exemplary and is simply being used to describe a type of programming construct that needs to be resolved so that the new function may be inserted into the running application 14.

Thus, if the new function source code 31 includes a header invocation, the compiling of the new function source code without resolving the header invocation with respect to the running application 14 will render the compiled new function useless. Therefore, during the preprocessing step 210, the compiler 28 collects the header files from the original source for the application 14. As described above, other types of programming constructs may also be collected during this step. It should also be noted that the preprocessing of the original source does not need to be performed in real time. That is, the memory 23 of the host 20 may store a version of the preprocessed original source to be used by the compiler 28 when needed. Thus, the developer may not need to invoke the preprocessing of the original source every time that the developer wants to insert a new function.

In step 220, the developer will modify the function using the editor 27. For example, as described above, the original source code for the application 14 is stored in the memory 23 of the host 20. Those skilled in the art will understand that application 14 may have tens, hundreds or even thousands of function files that make up the application 14. The developer will select the function that the developer desires to modify. The developer will then make the modifications using the editor 27 in the native language of the source code for the application 14 (e.g., C, C++, Java, etc.). The modification of the function in the original source is a much easier modification for the developer than modifying the function in some other format, such as binary, because the developer is generally more familiar with the source language and may have even written the original source for the function that will be modified. The result of the modification will be the new function source code 31 as shown as stored in memory 23.

It should be noted that throughout this description, the term new function has been used in connection with the scenario described above, e.g., the modification of an existing function within the application 14. However, the term new function could also apply to the situation where the developer is not making a change to an existing function, but is adding a function to the application 14. That is, the step 220 may include both the modification of an existing file or the writing of an additional function. In either case, the result will be the new function source code 31.

Once the source code for the new function is written, it needs to be compiled so that it can be inserted into the application 14 running on the target 10. However, those skilled in the art will understand that the simple act of compiling the new function source code 31 by the compiler 28 will not allow for insertion into the running application 14 because the new function, like the function it is replacing, needs to reference other portions of the application 14 for it to run properly. In addition, since the new function may be replacing an existing function within the application 14, it also needs to take over within the same context as the existing function. For example, if the function existing in the running application 14 includes a counter and at this point of execution on the target 10, the counter has reached five (5), when the new function takes over for the existing function, the counter of the new function should count in the same manner as the existing function, e.g., the next counted event should be six (6) and not one (1). Thus, the compiling of the new function source code 31 in a vacuum without reference to the original application will not allow for the new function to be inserted into the running application 14 on target 10.

In step 230, the patchpoint generator 29 also collects data from the application binary to determine the context and reference of the transformed objects. It should be understood that the step 230 for collecting of the data from the binary does not have to be performed at this time. As described, the collecting of the data is for use with the transformed source that will be described in greater detail below. Thus, at this particular time in the process the transformed source does not exist. Therefore, the collecting of this data from the binary may be performed at a later time. As described in the counter example provided above, the new function needs to replace the existing function in a seamless manner so the application 14 continues to execute in the correct manner. Thus, the patchpoint generator 29 collects this context data from the application binary 14. The DSM agent 12 on the target 10 will use this reference information to seamlessly reference the existing data during insertion of the replacement function. It should be noted that this is actual running data from the application 14 and not replicated data generated at the host 20. Thus, the data may continue to change as the application 14 continues to execute on target 10.

In step 240, the new function source code 31 is transformed using an algorithm and information obtained during the parsing of the preprocessed source file. Specifically, the preprocessed source code 31 is analyzed and parsed to determine the programming constructs that it invokes and the data it needs to be inserted into the running application 14. For example, the new function source code 31 may include the invocation of a specific header file. As described above, the patchpoint generator 29 typically will operate at the source code level and performs source code to source code transformations and will have all the information concerning the header files from the original source for the application 14. Thus, the patchpoint generator 29 may, for example, transform the objects and other language constructs found in the header file in the new function source code 31. In one example, a static variable may be transformed to an external variable so that when the new function is compiled by the language specific compiler, the generated binary can be analyzed to locate these transformed objects, which reference back to original application when the new function is inserted into the running application 14, the call to the header file is correctly interpreted by the target 10. Moreover, the compiler 28 uses the data collected in step 230 to reference variables within the new function source code to the correct context. To continue with the example started above, if the current context of the counter in the existing function is a count of five (5), the counter variable within the new function source code 31 points to the same counter so that its value will also be five (5) so that when the new function is inserted into the running application 14, the context remains the same.

After the transformation of the new function source code 31 has been performed in step 240, the compiler 28, in step 250, may then compile the transformed new function source code. As described above, since the new function source code 31 was transformed using the information from the original source code, the compiled new function source code will have the correct references and context with respect to the running application 14. This compilation may be performed according to the normal principles of compiling a function for the source code in which it has been written. Thus, at the end of step 250, the compiler has created the new function object code 32. This new function object code 32 is then ported or transmitted to the target 10 and stored in the memory 13. Then, in step 260, the new function object code 32 is executed within the running application 14 in place of the existing function. Exemplary methods of inserting the new function object code were described above.

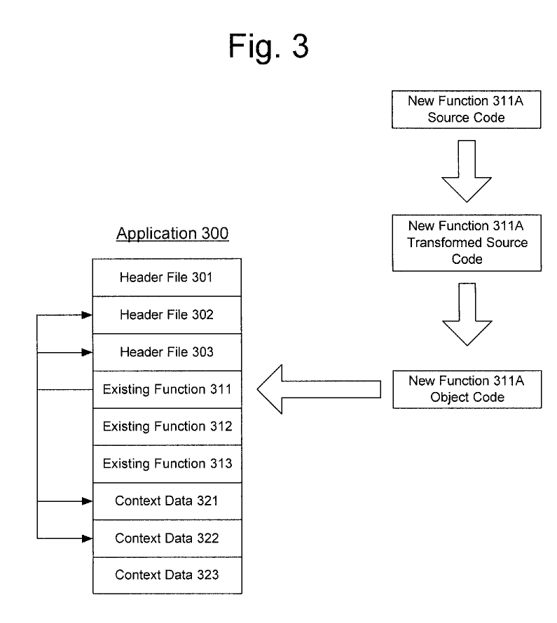

FIG. 3 shows an exemplary block diagram of a running application 300 and a new function 311A to be inserted into the running application according to an exemplary embodiment. Initially, running application 300 is shown as including three header files 301-303, three function 311-313 and three different sets of context data 321-323. Those skilled in the art will understand that the block diagram of application 300 is only intended to be an exemplary representation of various components of the running application 300. It is not intended to convey that each of the components in fact represents a file of the running application 300 or that theses may be the only components of running application 300. For example, the context data 321-323 is included as part of application 300, but is not part of the original source code nor is it normally stored in a separate file of the object code of the application 300. However, for the purposes of describing the exemplary embodiments, the context data is illustrated as individual blocks 321-323.

In this example, the focus will be on the existing function 311 of the running application 300 that will be eventually be replaced with new function 311A as will be described in greater detail below. As shown in FIG. 3, the existing function 311 invokes header files 302 and 303. In addition, the existing function 311 is dependent on the context data 321 and 322. The developer desires to replace existing function 311 with the new function 311A which is a modification of the existing function 311. Thus, as described above, the developer may modify the original source code of the existing function 311 to create the new function 311A source code. The compiler 28 will then transform the new function 311A source code into the new function 311A transformed source code. As described above, the new function 311A source code needs to be transformed so that it can be properly compiled to be inserted into the running application 300.

As described above, the transformation will include both transforming programming constructs within the new function 311A source code to properly reference the original source code of the application 300 and transforming variables within the new function 311A source code to properly maintain the context of the running application 300. Thus, the compiler 28, prior to compiling new function 311A source code, transforms the programming constructs and the variables of the new function 311A source code. In this example, the compiler will transform the references to the header files 302 and 303 based on the definitions of those header files in the original source code for the running application 300. For example, the references within the new function 311A source code to the header files 302 and 303 may be transformed to an external variable so that when the new function 311A is inserted into the running application 300, the device executing the code (e.g., target 10) is able to properly execute the code by calling the header files 302 and 303 within the new function 311A. As described above, this programming construct transformation is not limited to header files, but may also be applied to any other programming constructs within new function 311A that make a call or reference to code outside of new function 311A such as macros, conditionals, etc. In addition, the compiler 28 will also transform any variable references within the new function 311A source code to the context as currently stored in the context data 321 and 322 on which the existing function 311 relies. For example, as described above, a counter variable will be transformed to reference back to the value of that counter variable in the existing function 311 of running application 300.

After this transformation, the compiler 28 will compile the new function 311A transformed source code to new function 311A object code. This new function 311A object code may then be inserted into running application 300 to replace existing function 311. The running application 300 will continue to execute in the same manner as it had executed with existing application 311, except that any changes implemented by the new function 311A will be executed within the application 300.

As can be seen from above, the exemplary embodiments of the present invention allow a developer to modify a running application by inserting a new function without recompiling the entirety of the application, thereby saving the time and effort associated with such recompilation. In addition, the exemplary embodiments allow the developer to write this new function in the native source code of the application. The comparison of the new function programming constructs and data is performed automatically by comparing the original source and the new function source to transform the new function source to be compatible with the original source. Thus, the developer saves time and effort by both eliminating compilations of the full application and by being able to write the function edits in the original source language.

Those of skill in the art will understand that the exemplary embodiments of the present invention may be implemented as hardware, software or a combination of hardware and software. For example, the exemplary embodiments may be implemented as a set of instructions that are stored on a memory, the instructions being executable by a processor to be operable to perforin certain tasks.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A system comprising a memory storing a set of instructions executable by a processor, the set of instructions being operable to:
extract an original source code for an application, the original source code including source code for a function;
receive source code for a new function, the source code being a same type as the original source code, the new function to replace the function in the application;
determine information from one of the original source code and an execution of the application; and
transform the source code for the new function into transformed source code based on the information determined from the original source code.

2. The system of claim 1, wherein the instructions are further operable to:
compile the transformed source code into object code for the new function.

3. The system of claim 1, wherein the information is programming constructs of the original source code.

4. The system of claim 3, wherein the programming constructs include one of a header file, a macro and a conditional.

5. The system of claim 3, wherein the transforming includes changing a static reference in the source code for the new function to an external variable reference.

6. The system of claim 1, wherein the information is context data from the execution of the application.

7. The system of claim 6, wherein the transforming includes changing a reference of a variable in the source code for the new function to context data.

8. The system of claim 1, wherein the type of the original source code is one of C, C++, and Java.

9. The system of claim 1, wherein the instructions are further operable to:
modify the source code for the function to create the source code for the new function.

10. A system, comprising:
a target device executing an application; and
a host device generating a new function to replace an existing function in the executing application of the target device, wherein the generating includes extracting an original source code for the application, the original source code including source code for the exiting function, receiving source code for the new function, the source code being a same type as the original source code, determining information from one of the original source code and the execution of the application on the target device and transforming the source code for the new function into transformed source code based on the information determined from the original source code.

11. The system of claim 10, wherein the host device further compiles the transformed source code into object code for the new function.

12. The system of claim 11, wherein the target device receives the object code for the new function and executes the new function as a replacement for the existing function within the application.

13. The system of claim 10, wherein the information is programming constructs of the original source code.

14. The system of claim 13, wherein the programming constructs include one of a header file, a macro and a conditional.

15. The system of claim 13, wherein the transforming includes changing a static reference in the source code for the new function to an external variable reference.

16. The system of claim 10, wherein the information is context data from the execution of the application.

17. The system of claim 16, wherein the transforming includes changing a reference of a variable in the source code for the new function to context data.

18. The system of claim 10, wherein the type of the original source code is one of C, C++, and Java.

19. The system of claim 10, wherein the host further modifies the source code for the function to create the source code for the new function.

20. A system, comprising:
means for extracting an original source code for an application, the original source code including source code for a function;
means for receiving source code for a new function, the source code being a same type as the original source code, the new function to replace the function in the application;
means for determining information from one of the original source code and an execution of the application; and
means for transforming the source code for the new function into transformed source code based on the information determined from the original source code.
